(19) United States
(12) Patent Application Publication
(10) Pub. No.: US 2025/0133542 A1
(43) Pub. Date: Apr. 24, 2025

(54) TERMINAL, RADIO COMMUNICATION METHOD, AND BASE STATION

(71) Applicant: NTT DOCOMO, INC., Tokyo (JP)

(72) Inventors: Daisuke Kurita, Tokyo (JP); Hiroki Harada, Tokyo (JP); Mayuko Okano, Tokyo (JP); Satoshi Nagata, Tokyo (JP); Masaya Okamura, Tokyo (JP); Tomoya Ohara, Tokyo (JP)

(73) Assignee: NTT DOCOMO, INC., Tokyo (JP)

(21) Appl. No.: 18/704,851

(22) PCT Filed: Oct. 29, 2021
(86) PCT No.: PCT/JP2021/039974

§ 371 Date: Apr. 25, 2024

(51) Int. Cl. H04W 72/0446

(52) U.S. Cl. CPC H04W 72/0446

(57) ABSTRACT

A terminal according to one aspect of the present disclosure includes: a control section configured to determine a resource in which an uplink (UL) signal resource and a downlink (DL) signal resource are configurable in the same time resource in one physical resource block; and a transmitting/receiving section configured to perform, in the resource to be determined, at least one of reception of a specific DL signal used for initial access and transmission of a specific UL signal used for initial access. According to one aspect of the present disclosure, overhead can be reduced and resource utilization efficiency can be increased.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). Furthermore, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

### CITATION LIST

### Non Patent Literature

Non Patent Literature 1: 3GPP TS 36.300 V8. 12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In a future radio communication system, it is assumed that a plurality of user terminals (user terminal, user equipment (UE)) perform communication in an ultra-dense and high-traffic environment.

Under such an environment, it has been studied that communication using full duplex (FD) is performed as one of purposes of improving resource utilization efficiency.

However, in the NR specification so far, a communication method using the FD has not been sufficiently studied. If the method is not sufficiently studied, system performance may deteriorate due to an increase in delay or deterioration in coverage performance.

Therefore, an object of the present disclosure is to provide a terminal, a radio communication method, and a base station that improve resource utilization efficiency.

### Solution to Problem

A terminal according to one aspect of the present disclosure includes: a control section configured to determine a resource in which an uplink (UL) signal resource and a downlink (DL) signal resource are configurable in the same time resource in one physical resource block; and a transmitting/receiving section configured to perform, in the resource to be determined, at least one of reception of a specific DL signal used for initial access and transmission of a specific UL signal used for initial access.

### Advantageous Effects of Invention

According to one aspect of the present disclosure, overhead can be reduced and resource utilization efficiency can be increased.

### BRIEF DESCRIPTION OF DRAWINGS

FIGS. 1A to 1E are diagrams illustrating an example of a duplex system.

FIGS. 2A to 2C are diagrams illustrating an example of a configuration of a UL resource and a DL resource according to a first embodiment.

FIG. 3 is a diagram illustrating an example of determining the UL and DL resources according to an embodiment 2-1.

FIG. 4 is a diagram illustrating an example of determining the UL and DL resources according to an embodiment 2-2.

FIG. 5 is a diagram illustrating an example of operation of a UE according to a second embodiment.

FIG. 6 is a diagram illustrating an example of a schematic configuration of a radio communication system according to one embodiment.

FIG. 7 is a diagram illustrating an example of a configuration of a base station according to one embodiment.

FIG. 8 is a diagram illustrating an example of a configuration of a user terminal according to one embodiment.

FIG. 9 is a diagram illustrating an example of a hardware configuration of the base station and the user terminal according to one embodiment.

FIG. 10 is a diagram illustrating an example of a vehicle according to one embodiment.

### DESCRIPTION OF EMBODIMENTS

In a future radio communication system, higher required performance and various use cases are assumed.

As an example of various use cases, super coverage enhancement/super long range communication, super capacity enlargement, super reliable communication, a virtual cell (User centric no cell), a flexible network (NW), a mesh NW/sidelink, and the like are considered.

In the future radio communication system (for example, Rel. 18 or later), specification/practical application of communication using full duplex (FD) has been studied.

As a method of initial access, a design in communication using the various use cases and the FD has been studied.

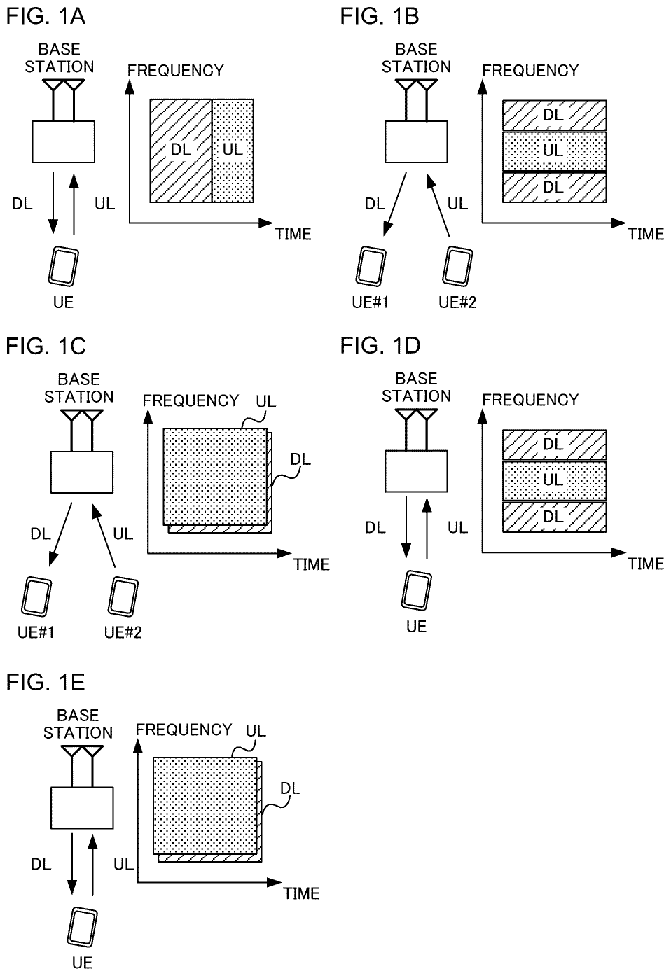

A method illustrated in FIGS. 1A to 1E is considered as a duplex mode.

A base station and a UE perform communication by being temporally switched in the same frequency band in an uplink (UL) and a downlink (DL) (time division duplex (TDD), refer to FIG. 1A). In this case, the base station and the UE do not perform a FD operation.

The base station performs communication of the UL and the DL of each of the plurality of UEs by dividing frequencies at the same time (frequency division duplex (FDD), refer to FIG. 1B). In this case, the base station performs the FD operation, and the UE does not perform the FD operation. In addition, a UL frequency resource and a DL frequency resource do not overlap each other.

The base station performs communication of the UL and DL of each of the plurality of UEs using the same time/frequency resources (by performing spatial multiplexing) (refer to FIG. 1C). In this case, the base station performs the FD operation, and the UE does not perform the FD operation. In addition, the UL frequency resource and the DL frequency resource overlap each other (entirely or at least partially overlap each other).

The base station performs communication of the UL and the DL of one UE by dividing the frequency at the same time (refer to FIG. 1D). In this case, the base station and the UE perform the FD operation. In addition, a UL frequency resource and a DL frequency resource do not overlap each other.

The base station performs communication of the UL and the DL of one UE by using the same time/frequency resources (by performing spatial multiplexing) (refer to FIG. 1E). In this case, the base station and the UE perform the FD operation. In addition, the UL frequency resource and the DL frequency resource overlap each other (entirely or at least partially overlap each other).

The FD in which the UL frequency resource and the DL frequency resource do not overlap each other may be referred to as a subband based FD (sub-band based FD). The FD in which the UL frequency resource and the DL frequency resource overlap each other (all or at least partially) may be referred to as a spectrum sharing FD.

### (Analysis)

Further utilization of a high frequency band is expected for super capacity enlargement in the future radio communication system in which utilization of the high frequency band is realized in NR.

On the other hand, in order to compensate for propagation loss in the high frequency band, narrowing of a band of an antenna beam and an increase in the number of antenna beams accompanying the narrowing have been studied.

For DL synchronization signals (for example, SS/PBCH block, SSB) and UL random access channel opportunities (RACH occasion (RO)), resources need to be allocated to each antenna beam in advance. In particular, in a system using TDD, it is necessary to configure a resource for each of the UL and the DL.

Here, by introducing the FD operation as described above, it is considered that the UL and the DL can be configured using at least the same time resource for each antenna beam.

However, in the NR specification so far, a communication method using the FD has not been sufficiently studied. If the method is not sufficiently studied, system performance may deteriorate due to an increase in delay or deterioration in coverage performance.

Therefore, the present inventors have conceived a communication method using the FD.

Hereinafter, embodiments according to the present disclosure will be described in detail with reference to the drawings. The radio communication method according to each of the embodiments may be applied independently, or may be applied in combination with others.

In the present disclosure, “A/B” and “at least one of A or B” may be interchangeable with each other. Furthermore, in the present disclosure, “A/B/C” may mean “at least one of A, B, and C”.

In the present disclosure, activate, deactivate, instruct (or indicate), select, configure, update, determine, and the like may be interchangeable with each other. In the present disclosure, support, control, can control, operate, can operate, and the like may be interchangeable with each other.

In the present disclosure, radio resource control (RRC), an RRC parameter, an RRC message, an upper layer parameter, an information element (IE), a setting, and the like may be interchangeable with each other. In the present disclosure, a Medium Access Control control element (MAC control element (CE)), an update command, an activation/deactivation command, and the like may be interchangeable with each other.

In the present disclosure, the higher layer signaling may be any of, for example, radio resource control (RRC) signaling, medium access control (MAC) signaling, broadcast information, and the like, or a combination thereof.

In the present disclosure, the MAC signaling may use, for example, the MAC control element (MAC CE), a MAC protocol data unit (PDU), or the like. The broadcast information may be, for example, a master information block (MIB), a system information block (SIB), remaining minimum system information (RMSI), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeable with each other. In the present disclosure, a sequence, a list, a set, a group, a cohort, a cluster, a subset, and the like may be interchangeable with each other.

In the present disclosure, a panel, a UE panel, a panel group, a beam, a beam group, a precoder, an uplink (UL) transmission entity, a transmission and reception point (transmission/reception point (TRP)), a base station, spatial relation information (SRI), a spatial relation, an SRS resource indicator (SRI), a control resource set (CORESET), a physical downlink shared channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a physical uplink control channel (PUCCH) group, or a PUCCH resource group), a resource (for example, a reference signal resource and an SRS resource), a resource set (for example, a reference signal resource set), a CORESET pool, a downlink transmission configuration indication state (TCI state) (DL TCI state), an uplink TCI state (UL TCI state), a unified TCI state, a common TCI state, a quasi-co-location (QCL), QCL assumption, and the like may be interchangeable with each other.

### (Radio Communication Method)

In the present disclosure, a signal and a channel may be interchangeable with each other. In the present disclosure, a signal, a channel, a signal/channel, DL reception, and UL transmission may be interchangeable with each other.

In the following embodiments of the present disclosure, signals/channels used for initial access will be mainly described for DL signals/channels and UL signals/channels, but each signal/channel may be a signal/channel not used for initial access.

### First Embodiment

A resource available for DL reception/UL transmission may be stipulated. The resource may be a resource common to a plurality of UEs.

The resource available for the DL reception/the UL transmission may be allocated in unit of specific frequency/time resource. The unit of the frequency resource of the resource may be a specific number (for example, one) of PRBs/subPRBs/PRGs/BWPs/CCs/bands. The unit of the time resource of the resource may be a specific number (for example, one) of symbols/slots/subslots/subframes.

The UE may receive a DL signal/channel in a specific DL resource within the DL reception/UL transmission available resources. The UE may transmit a UL signal/channel in a specific UL resource within the DL reception/UL transmission available resources.

The DL signal/channel in each embodiment of the present disclosure may be, for example, a DL synchronization signal (for example, at least one of PSS, SSS, and SSB), a broadcast channel (for example, PBCH), or a combination thereof (for example, SS/PBCH block).

The UL signal/channel in each embodiment of the present disclosure may be, for example, at least one of a random access channel (random access preamble/PRACH), a message 3 (UL grant for random access response), and a UL signal/channel that triggers a specific DL signal/channel.

At least one of the DL signal/channel and the UL signal/channel in each embodiment of the present disclosure may be a signal/channel used for initial access.

A DL signal/channel resource and a UL signal/channel resource in each embodiment of the present disclosure may be allocated in a specific frequency/time resource unit. The specific frequency resource may be a specific number (for example, one) of PRBs/subPRBs/PRGs/BWPs/CCs/bands. The specific time resource may be a specific number (for example, one) of symbols/slots/subslots/subframes.

The specific DL resource and the specific UL resource may be, for example, resources in at least one of embodiments 1-1 and 1-2 described below.

### Embodiment 1-1

All or at least a part of a time resource of the specific DL resource and a time resource of the specific UL resource may overlap each other.

A frequency resource of the specific DL resource and a frequency resource of the specific UL resource may overlap each other. In other words, the same frequency resource may be used for the specific DL resource and the specific UL resource.

In addition, the frequency resource of the specific DL resource and the frequency resource of the specific UL resource may partially overlap each other.

When the specific DL resource and the specific UL resource overlap each other in a frequency domain (entirely or at least partially overlap each other) in the same time resource, a certain UE among the plurality of UEs may use the specific DL resource, and another UE among the plurality of UEs may use the specific UL resource.

When the specific DL resource and the specific UL resource overlap each other in the frequency domain (entirely or at least partially overlap each other) in the same time resource, one UE may use at least one of the specific DL resource and the specific UL resource.

In addition, the frequency resource of the specific DL resource and the frequency resource of the specific UL resource may not overlap each other. In other words, different frequency resources may be used for the specific DL resource and the specific UL resource. The specific DL resource and the specific UL resource may be used in a plurality of UEs or may be used in one UE.

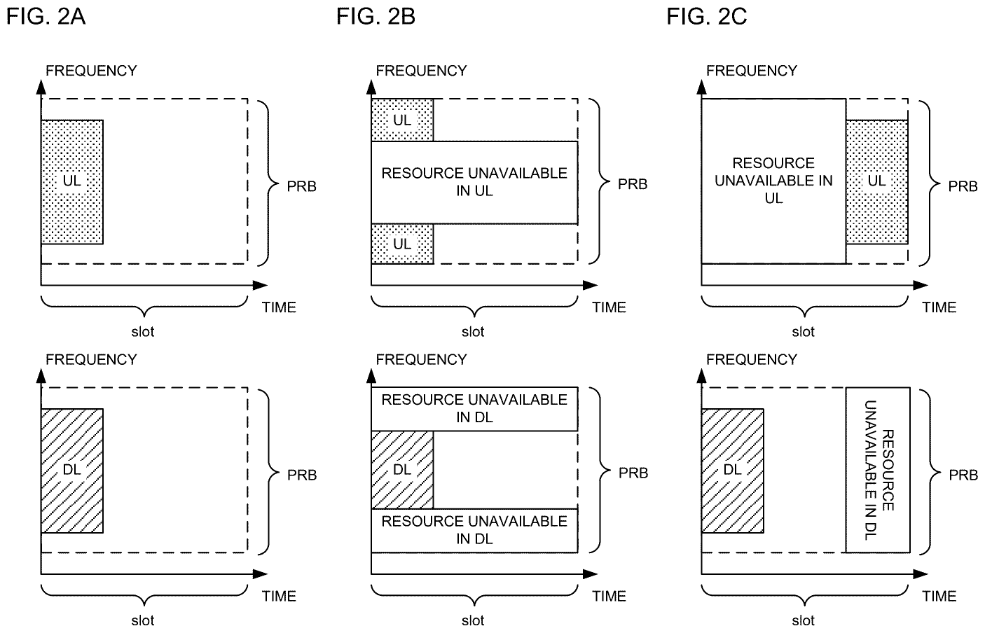

FIG. 2A is a diagram illustrating an example of a configuration of the UL resource and the DL resource according to the embodiment 1-1. In the example illustrated in FIG. 2A, resources available for the DL and the UL are indicated by broken lines. In FIG. 2A, resources used for the UL signal/channel and the DL signal/channel are respectively configured. In the example of FIG. 2A, the resource used for the UL signal/channel and the resource used for the DL signal/channel overlap each other in the time domain and the frequency domain.

FIG. 2B is a diagram illustrating another example of the configuration of the UL resource and the DL resource according to the embodiment 1-1. In the example illustrated in FIG. 2B, similarly to FIG. 2A, resources available for the DL and the UL are indicated by broken lines. In FIG. 2B, resources used for the UL signal/channel and the DL signal/channel are respectively configured. In the example of FIG. 2B, the resource used for the UL signal/channel and the resource used for the DL signal/channel overlap each other in the time domain. A frequency resource available in the UL resource becomes a resource unavailable in the DL, and a frequency resource available in the DL resource becomes a resource unavailable in the UL.

According to the embodiment 1-1, notification of the time resource to the UE is unnecessary, and overhead can be reduced.

### Embodiment 1-2

The time resource of the specific DL resource and the time resource of the specific UL resource may not overlap each other. In other words, different time resources may be respectively used for the specific DL resource and the specific UL resource.

FIG. 2C is a diagram illustrating another example of the configuration of the UL resource and the DL resource according to the embodiment 1-2. In the example illustrated in FIG. 2C, similarly to FIG. 2A, resources available for the DL and the UL are indicated by broken lines. In FIG. 2C, resources used for the UL signal/channel and the DL signal/channel are respectively configured. In the example of FIG. 2C, the resource used for the UL signal/channel and the resource used for the DL signal/channel do not overlap each other in the time domain. A time resource available in the UL resource becomes a resource unavailable in the DL, and a time resource available in the DL resource becomes a resource unavailable in the UL.

It is noted that the scale of the time/frequency resources illustrated in FIG. 2A to FIG. 2C is not limited to the described example. For example, the unit of the time resource may be a slot/symbol/subslot/subframe. In addition, the unit of the frequency resource may be a physical resource block (PRB)/subPRB/PRB group (PRG)/BWP/CC. In other words, in the present disclosure, the time resource of the specific DL/UL resource may be specified/configured in the slot unit/symbol unit/subslot unit/subframe unit, or the frequency resource of the specific DL/UL resource may be specified/configured in the PRB unit/subPRB unit/PRG unit/BWP unit/CC unit.

In a first embodiment, the DL signal/channel may include specific information on one or more initial accesses.

The specific information on the initial access may include information on PDCCH monitoring.

The information on PDCCH monitoring may include, for example, information of a resource configuration in random access (RACH). The information of the resource configuration may be, for example, information for configuring a resource of a specific message (for example, message 2/4) in random access.

The information on PDCCH monitoring may include, for example, information of a resource configuration of system information. The information of the resource configuration may be, for example, information for configuring a resource of system information (for example, remaining minimum system information (RMSI)). This can be suitably used in the operation as in the embodiment 1-2 described above.

In addition, the information of the resource configuration of the system information may include a field instructing acquisition of the system information. According to this, the operation can be suitably performed in a case where the UE is not notified of necessary information by a broadcast channel.

For example, in the embodiment 1-1 described above, the specific information on the initial access may not include information on a time/frequency resource of a UL signal/channel.

Furthermore, for example, in the embodiment 1-1 described above, the specific information on the initial access may include the information on the time/frequency resource of the UL signal/channel. The information on the time/frequency resource may be indicated by, for example, an offset from a specific time/frequency (reference time/frequency (for example, time/frequency of a synchronization signal (SSB))).

For example, in the embodiment 1-2 described above, the UE may configure the time/frequency resource of the UL signal/channel by using the information on the system information (for example, RMSI) included in the specific information on the initial access.

The specific information on the initial access may include information on a specific UL signal/channel. The information on the specific UL signal/channel may include, for example, at least one of information on a format of RACH and information on the number (total number) of random access preambles.

The UE may receive the specific information on the initial access including the at least one piece of information by using the DL signal/channel.

As described above, according to the first embodiment, even in a case where the time/frequency resources in the DL/UL resources partially or entirely overlap each other, transmission and reception of the signal/channel can be appropriately performed.

### Second Embodiment

A configuration in which the time resource of the DL signal/channel and the time resource of the UL signal/channel do not coincide with each other may be supported/allowed.

The configuration in which the time resource of the DL signal/channel and the time resource of the UL signal/channel do not coincide with each other may be at least one of a case in which start timings of respective time resources do not coincide with each other and a case in which lengths of respective time resources do not coincide with each other.

The UE may assume/expect that the time resource of the DL signal/channel and the time resource of the UL signal/channel are configured in a different manner.

The start timing of the time resource of the DL signal/channel and the start timing of the time resource of the UL signal/channel may or may not coincide with each other.

The UE may determine/decide at least one of the resource of the DL signal/channel to be used and the resource of the UL signal/channel to be used based on (the length of) the time resource of the DL signal/channel and (the length of) the time resource of the UL signal/channel.

### Embodiment 2-1

The time resource of the DL signal/channel may be configured to be shorter than the time resource of the UL signal/channel.

The UE may receive the DL signal/channel in an additional DL time resource, in addition to the DL time resource to be configured. A frequency resource corresponding to the additional DL time resource may be the same as a frequency resource corresponding to the DL time resource to be configured in advance.

An additional time resource may have the same length as that of the time resource of the DL signal/channel to be configured, or may have a different length.

The additional time resource may be determined such that a total DL time resource (the sum of the time resource to be configured and the additional time resource) has the same length as that of the time resource of the UL signal/channel to be configured.

The UE may repeatedly receive the DL signal/channel in the time resource and an additional DL resource to be configured (embodiment 2-1-1).

The UE may receive at least one of information on the presence or absence of repetition and information on the number of repetitions by using the DL signal/channel. The UE may receive the information by using the DL time resource to be configured.

The UE may receive a specific DL signal/channel in the additional DL resource (embodiment 2-1-2).

The specific DL signal/channel may be, for example, a broadcast channel. At this time, the UE may not receive a synchronization signal in the additional DL resource.

The UE may receive at least one of information on the presence or absence of addition of the resource and information on the additional resource by using the DL signal/channel. The information on the additional resource may be indicated in a specific time unit (for example, in unit of symbol). The UE may receive the information by using the DL time resource to be configured.

The UE may receive the specific DL signal/channel in the additional DL resource (embodiment 2-1-3).

The specific DL signal/channel may be, for example, a signal/channel in which a resource is configured for each antenna beam. The specific DL signal/channel may be, for example, at least one of a PDCCH, a piece of system information (for example, RMSI), and a positioning reference signal (PRS).

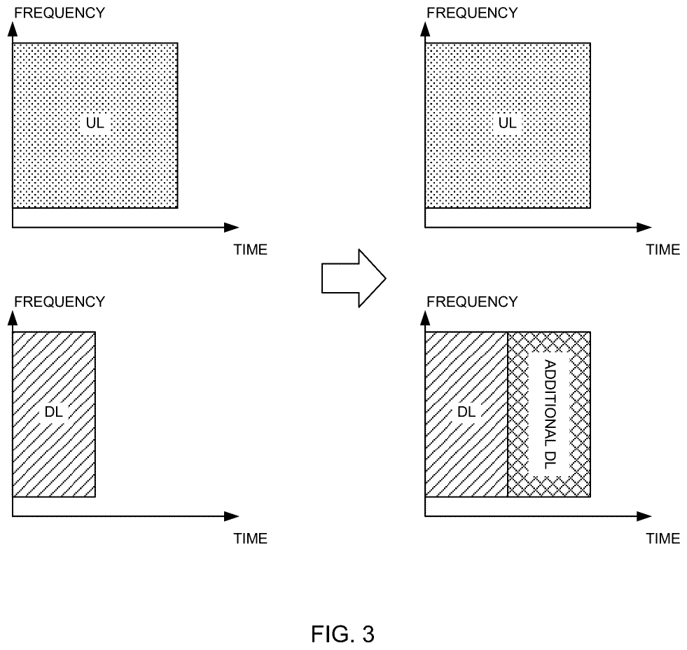

FIG. 3 is a diagram illustrating an example of determination of the UL and DL resources according to the embodiment 2-1. In the example illustrated in FIG. 3, the UL resource and the DL resource are configured for the UE. At this time, a length of the UL resource is larger than a length of the DL resource.

In the example illustrated in FIG. 3, the UE determines the additional DL resource in addition to the DL resource to be configured.

In the existing NR (up to Rel. 16), for example, there is a case in which a resource (symbol) for UL signal/channel (PRACH) is configured to be longer than a resource (symbol) for DL signal/channel (SSB). According to the embodiment 2-1, in such a case, utilization efficiency of the DL resource can be improved.

### Embodiment 2-2

The time resource of the DL signal/channel may be configured to be longer than the time resource of the UL signal/channel.

The UE may transmit the UL signal/channel in an additional UL time resource using the same frequency resource in addition to the UL time resource to be configured.

The additional time resource may have the same length as that of the time resource of the UL signal/channel to be configured, or may have a different length.

The additional time resource may be determined such that a total UL time resource (the sum of the time resource to be configured and the additional time resource) has the same length as that of the time resource of the DL signal/channel to be configured.

The UE may determine a transmission opportunity of the UL signal/channel in the time resource to be configured and an additional UL resource (embodiment 2-2-1).

The UE may make RACH transmission opportunities (RACH occasion (RO)) consecutive (repeated) in the time direction in the additional UL resource.

The UE may receive at least one of information on the presence or absence of repetition and information on the number of repetitions (the number of ROs in the time direction) by using the DL signal/channel.

The UE may transmit the UL signal/channel in at least one of the time resource to be configured and the additional UL resource.

When performing transmission of the UL signal/channel in both the time resource and the additional UL resource to be configured, the UE may perform transmission of the UL signal/channel by switching beams between the RO in the time resource to be configured and the RO in the additional UL resource.

The UE may transmit a specific UL signal/channel in the additional UL resource (embodiment 2-2-2).

The specific UL signal/channel may be, for example, a signal/channel in which a resource is configured for each antenna beam. The specific UL signal/channel may be, for example, at least one of a PUCCH, an SR, a PUSCH, and a configured grant (CG-) PUSCH.

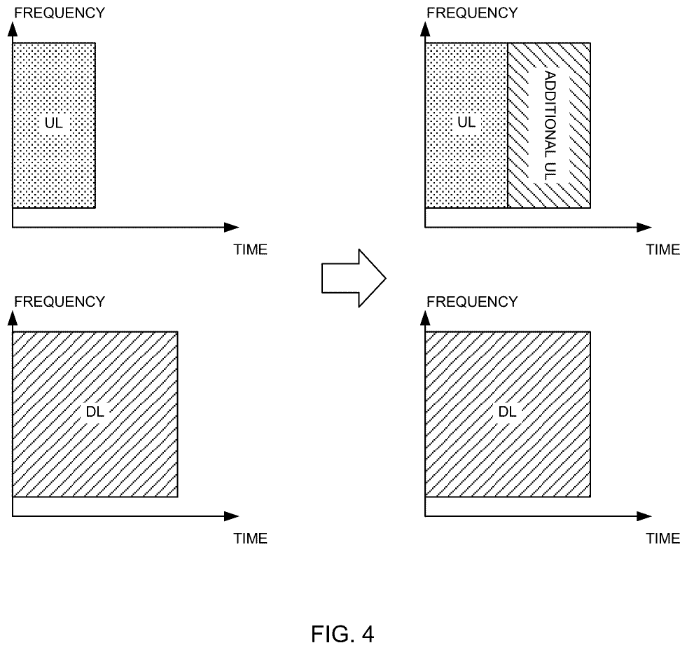

FIG. 4 is a diagram illustrating an example of determination of the UL and DL resources according to the embodiment 2-2. In the example illustrated in FIG. 4, the UL resource and the DL resource are configured for the UE. At this time, the length of the DL resource is larger than the length of the UL resource.

In the example illustrated in FIG. 4, the UE determines the additional UL resource in addition to the UL resource to be configured.

It is noted that, in the second embodiment, the DL signal/channel and the UL signal/channel respectively serving as targets may be separately defined for each of the embodiments 2-1 and 2-2. For example, when the embodiment 2-1 is applied, the target DL signal/channel may include at least one of a synchronization signal, a broadcast channel, a PDCCH, system information, and a PRS. For example, when the embodiment 2-2 is applied, the target UL signal/channel may include at least one of a channel/signal related to random access, a UL signal/channel that triggers a specific DL signal/channel, a PUCCH, an SR, and a CG-PUSCH.

Further, in the embodiment 2-2, in order to transmit and receive the DL signal/channel and the UL signal/channel in the same time resource, (the reception resource of) the DL signal/channel may be consecutively configured according to the transmission of the UL signal/channel (RO).

Even in a case where the resource for the UL signal/channel is configured to be shorter than the resource for the DL signal/channel in the future radio communication system, according to the embodiment 2-2, utilization efficiency of the UL resource can be improved.

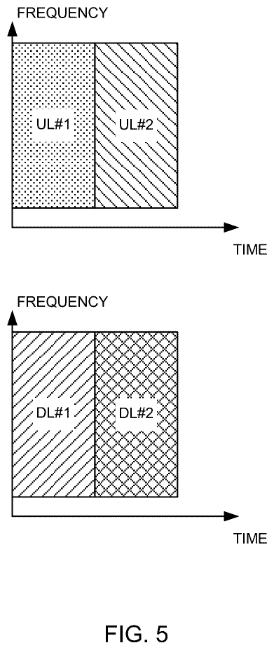

FIG. 5 is a diagram illustrating an example of operation of the UE according to the second embodiment. In FIG. 5, in the UE, UL resources (UL #1 and UL #2) and a DL resource (DL #1) are configured. In the example of FIG. 5, the time resource of the UL resource to be configured is configured to be longer than the time resource of the DL resource to be configured. Therefore, the UE determines an additional DL resource (DL #2).

In the example of FIG. 5, the UE receives a DL signal (for example, a synchronization signal) in the DL resource #1 (DL #1) to be configured. At this time, the UE transmits a UL signal (for example, a random access channel) in the UL resource (UL #2) of the same time resource as the DL resource to be added based on the DL signal. At this time, the UE may not receive the DL signal/channel in the additional DL resource (DL #2).

As described above, according to the second embodiment, even if the DL and UL resources to be configured have different time resources, transmission and reception of the DL signal/channel and the UL signal/channel can be performed without lowering the resource utilization efficiency.

### Other Embodiments

A higher layer parameter (RRC IE)/UE capability corresponding to a function (feature) in at least one of the plurality of embodiments described above may be defined. The UE capability may be indicated to support this function.

The UE in which the higher layer parameter corresponding to the function (enabling the function) is configured may perform the function. “The UE in which the higher layer parameter corresponding to the function is not configured does not perform the function (for example, according to Rel. 15/16)” may be defined.

The UE that has reported the UE capability indicating support for the function may perform the function. “The UE that does not report the UE capability indicating support for the function does not perform the function (for example, according to Rel. 15/16)” may be defined.

When the UE reports the UE capability indicating to support the function, and a higher layer parameter corresponding to the function is configured, the UE may perform the function. “When the UE does not report the UE capability indicating to support the function or the higher layer parameter corresponding to the function is not configured, the UE does not perform the function (for example, according to Rel. 15/16)” may be defined.

The UE capability may indicate whether the UE supports this function.

The function may be reception of the DL signal/channel and transmission of the UL signal/channel in the same time resource.

The UE capability may be defined as whether to support reception of the DL signal/channel and transmission of the UL signal/channel in the same time resource.

The UE capability may be defined by whether to support addition of the DL resource.

The UE capability may be defined by whether to support addition of the UL resource.

The UE capability may be defined by which channel/signal is supported in the added DL/UL resource.

According to the other embodiments described above, the UE can realize the above-described functions while maintaining compatibility with existing specifications.

### (Radio Communication System)

Hereinafter, a configuration of a radio communication system according to one embodiment of the present disclosure will be described. In this radio communication system, communication is performed using any one of the radio communication methods according to the embodiments of the present disclosure or a combination thereof.

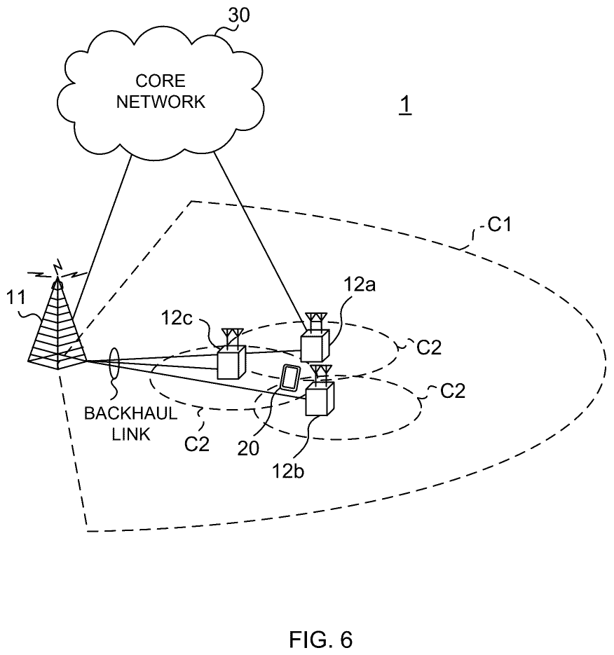

FIG. 6 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs).

The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is MN, and an LTE (E-UTRA) base station (eNB) is SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency band (frequency range 1 (FR1)) or a second frequency band (frequency range 2 (FR2)). The macro cell C1 may be included in the FR1, and the small cell C2 may be included in the FR2. For example, the FR1 may be a frequency band of 6 GHz or less (sub-6 GHZ), and the FR2 may be a frequency band higher than 24 GHZ (above-24 GHZ). It is noted that the frequency bands, definitions, and the like of the FR1 and FR2 are not limited thereto, and, for example, the FR1 may correspond to a frequency band higher than the FR2.

Further, the user terminal 20 may perform communication on each CC using at least one of time division duplex (TDD) and frequency division duplex (FDD).

The plurality of base stations 10 may be connected to each other in a wired manner (for example, an optical fiber, an X2 interface, or the like in compliance with common public radio interface (CPRI)) or in a radio manner (for example, NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), next generation core (NGC), or the like.

The user terminal 20 may be a terminal that corresponds to at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. It is noted that in the radio communication system 1, another radio access method (for example, another single carrier transmission method or another multi-carrier transmission method) may be used as the UL and DL radio access method.

In the radio communication system 1, a downlink shared channel (physical downlink shared channel (PDSCH)) shared by the user terminals 20, a broadcast channel (physical broadcast channel (PBCH)), a downlink control channel (physical downlink control channel (PDCCH)), and the like may be used as downlink channels.

In the radio communication system 1, an uplink shared channel (physical uplink shared channel (PUSCH)) shared by the user terminals 20, an uplink control channel (physical uplink control channel (PUCCH)), a random access channel (physical random access channel (PRACH)), and the like may be used as uplink channels.

User data, higher layer control information, a system information block (SIB), and the like are transmitted on the PDSCH. The user data, higher layer control information, and the like may be transmitted on the PUSCH. Furthermore, a master information block (MIB) may be transmitted on the PBCH.

Lower layer control information may be transmitted on the PDCCH. The lower layer control information may include, for example, downlink control information (DCI) including scheduling information of at least one of the PDSCH and the PUSCH.

It is noted that the DCI that schedules the PDSCH may be referred to as DL assignment, DL DCI, or the like, and the DCI that schedules PUSCH may be referred to as UL grant, UL DCI, or the like. It is noted that the PDSCH may be interchangeable with DL data, and the PUSCH may be interchangeable with UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. UE may monitor CORESET associated with a certain search space based on search space configuration.

One search space may correspond to a PDCCH candidate corresponding to one or more aggregation levels. One or more search spaces may be referred to as a search space set. It is noted that “search space”, “search space set”, “search space configuration”, “search space set configuration”, “CORESET”, “CORESET configuration”, and the like in the present disclosure may be interchangeable with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), and scheduling request (SR) may be transmitted on the PUCCH. A random access preamble for establishing connection with a cell may be transmitted on the PRACH.

It is noted that in the present disclosure, downlink, uplink, and the like may be expressed without “link”. Various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), or the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. It is noted that, the SS, the SSB, or the like may also be referred to as a reference signal.

Furthermore, in the radio communication system 1, a measurement reference signal (sounding reference signal (SRS)), a demodulation reference signal (DMRS), or the like may be transmitted as an uplink reference signal (UL-RS). It is noted that, the DMRSs may be referred to as “user terminal-specific reference signals (UE-specific reference signals)”.

### (Base Station)

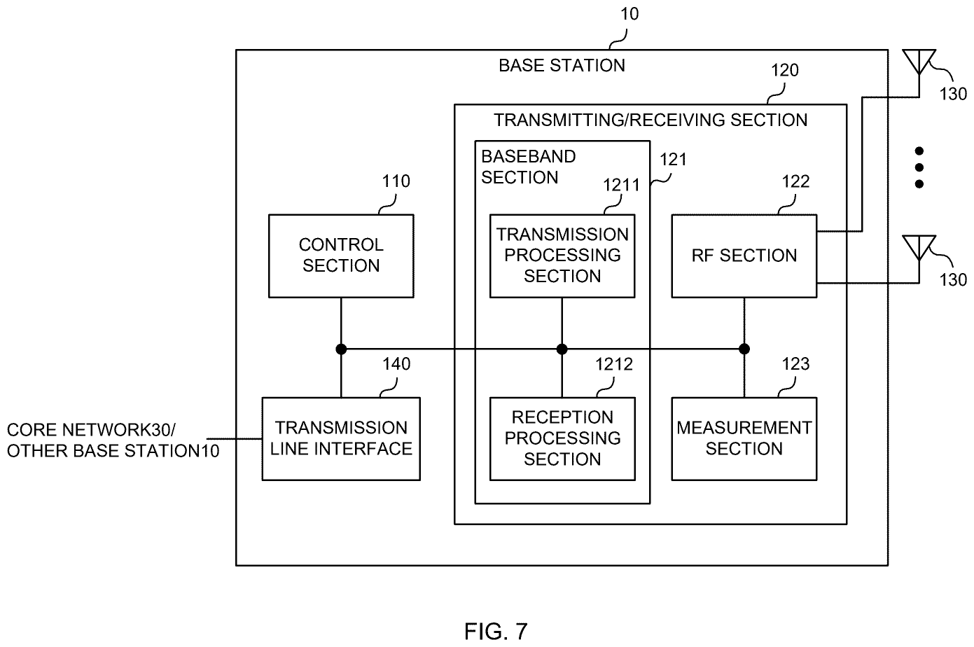

FIG. 7 is a diagram illustrating an example of a configuration of the base station according to one embodiment. The base station 10 includes a control section 110, a transmitting/receiving section 120, a transmitting/receiving antenna 130, and a transmission line interface 140. It is noted that one or more of the control sections 110, one or more of the transmitting/receiving sections 120, one or more of the transmitting/receiving antennas 130, and one or more of the transmission line interfaces 140 may be included.

It is noted that this example mainly describes a functional block which is a characteristic part of the present embodiment, and it may be assumed that the base station 10 also has another functional block necessary for radio communication. A part of processing of each section described below may be omitted.

The control section 110 controls the entire base station 10. The control section 110 can be constituted by a controller, a control circuit, or the like, which is described based on common recognition in the technical field to which the present disclosure relates.

The control section 110 may control signal generation, scheduling (for example, resource allocation or mapping), and the like. The control section 110 may control transmission/reception, measurement, and the like using the transmitting/receiving section 120, the transmitting/receiving antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can be constituted by a transmitter/receiver, an RF circuit, a baseband circuit, a filter, a phase shifter, a measurement circuit, a transmission/reception circuit, and the like, which are described based on common recognition in the technical field to which the present disclosure relates.

The transmitting/receiving section 120 may be constituted as an integrated transmitting/receiving section, or may be constituted by a transmitting section and a receiving section. The transmitting section may include the transmission processing section 1211 and the RF section 122. The receiving section may be constituted by the reception processing section 1212, the RF section 122, and the measurement section 123.

The transmitting/receiving antenna 130 can be constituted by an antenna described based on common recognition in the technical field to which the present disclosure relates, for example, an array antenna.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam or a reception beam using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like on, for example, data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like on the baseband signal, and may transmit a signal in the radio frequency band via the transmitting/receiving antenna 130.

Meanwhile, the transmitting/receiving section 120 (RF section 122) may perform amplification, filtering processing, demodulation to a baseband signal, and the like on the signal in the radio frequency band received by the transmitting/receiving antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal, to acquire user data and the like.

The transmitting/receiving section 120 (measurement section 123) may perform measurement on the received signal. For example, the measurement section 123 may perform radio resource management (RRM) measurement, channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. A measurement result may be output to the control section 110.

The transmission line interface 140 may transmit/receive a signal (backhaul signaling) to and from an apparatus included in the core network 30, another base stations 10, and the like, and may acquire, transmit, and the like user data (user plane data), control plane data, and the like for the user terminal 20.

It is noted that, the transmitting section and the receiving section of the base station 10 in the present disclosure may include at least one of the transmitting/receiving section 120, the transmitting/receiving antenna 130, and the transmission line interface 140.

The control section 110 may determine a resource in which an uplink (UL) signal resource and a downlink (DL) signal resource can be configured in the same time resource in one physical resource block. The transmitting/receiving section 120 (which may be a transmitting section or a receiving section) may perform at least one of transmission of a specific DL signal used for initial access and reception of a specific UL signal used for initial access in the determined resource (first and second embodiments).

### (User Terminal)

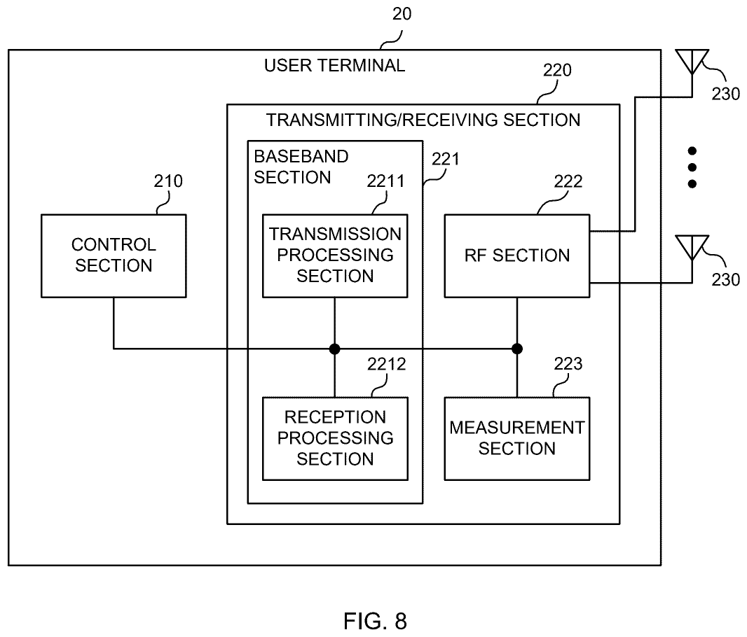

FIG. 8 is a diagram illustrating an example of a configuration of the user terminal according to one embodiment. The user terminal 20 includes a control section 210, a transmitting/receiving section 220, and a transmitting/receiving antenna 230. It is noted that one or more of the control sections 210, one or more of the transmitting/receiving sections 220, and one or more of the transmitting/receiving antennas 230 may be included.

It is noted that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described based on common recognition in the technical field related to the present disclosure.

The control section 210 may control signal generation, mapping, and the like. The control section 210 may control transmission/reception, measurement, and the like using the transmitting/receiving section 220 and the transmitting/receiving antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmission/reception circuit, and the like that are described based on common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may be configured by the reception processing section 2212, the RF section 222, and the measurement section 223.

The transmitting/receiving antenna 230 can include an antenna that is described based on common recognition in the technical field related to the present disclosure, for example, an array antenna or the like.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data, control information, and the like acquired from the control section 210, to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

It is noted that whether to apply DFT processing may be determined based on configuration of transform precoding. In a case where transform precoding is enabled for a certain channel (for example, PUSCH), the transmitting/receiving section 220 (transmission processing section 2211) may perform DFT processing as the transmission processing in order to transmit the channel using a DFT-s-OFDM waveform, and otherwise, DFT processing need not be performed as the transmission processing.

The transmitting/receiving section 220 (RF section 222) may perform modulation to a radio frequency band, filtering processing, amplification, and the like on the baseband signal, to transmit a signal in the radio frequency band via the transmitting/receiving antenna 230.

Meanwhile, the transmitting/receiving section 220 (RF section 222) may perform amplification, filtering processing, demodulation to a baseband signal, and the like on the signal in the radio frequency band received by the transmitting/receiving antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. A measurement result may be output to the control section 210.

It is noted that the transmitting section and the receiving section of the user terminal 20 in the present disclosure may include at least one of the transmitting/receiving section 220 and the transmitting/receiving antenna 230.

The control section 210 may determine a resource in which an uplink (UL) signal resource and a downlink (DL) signal resource can be configured in the same time resource in one physical resource block. The transmitting/receiving section 220 (which may be a transmitting section or a receiving section) may perform at least one of reception of a specific DL signal used for initial access and transmission of a specific UL signal used for initial access in the determined resource (first and second embodiments).

A frequency resource of the UL signal resource and a frequency resource of the DL signal resource may be configurable while at least partially overlapping each other (first embodiment).

The DL signal in the DL signal resource to be configured may include at least one of information on monitoring of a physical downlink control channel, system information, and information on the UL signal (first embodiment).

The control section 210 may determine at least one of the additional UL signal resource and the additional DL signal resource based on the length of the UL signal resource to be configured and the length of the DL signal resource to be configured (second embodiment).

### (Hardware Configuration)

It is noted that the block diagrams that have been used to describe the above embodiments illustrate blocks in functional units. These functional blocks (components) are implemented in arbitrary combinations of at least one of hardware and software. Further, the method of implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional blocks may be implemented by combining software with the above-described single apparatus or the above-described plurality of apparatuses.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

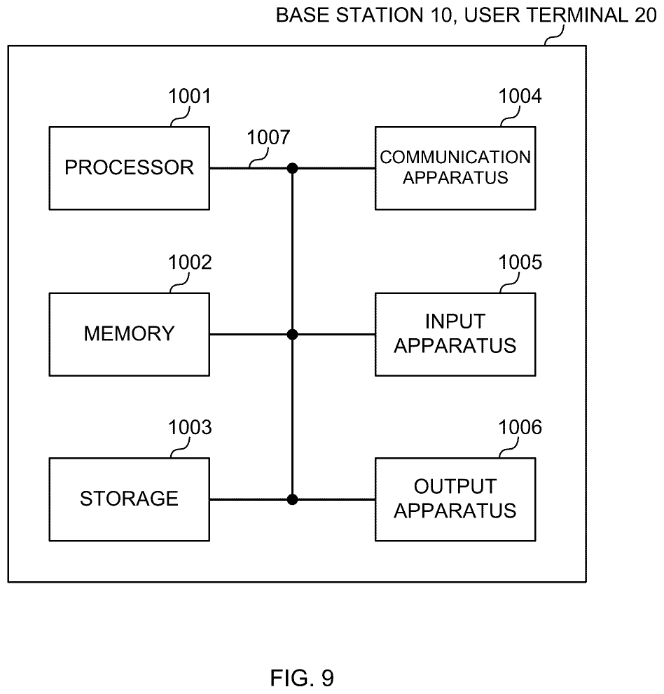

For example, the base station, the user terminal, and the like according to one embodiment of the present disclosure may function as a computer that executes the processing of the radio communication method of the present disclosure. FIG. 9 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

It is noted that in the present disclosure, the terms such as an apparatus, a circuit, a device, a section, and a unit can be interchangeable with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be included. Further, the processing may be executed by one processor, or the processing may be executed by two or more processors simultaneously or sequentially, or using other methods. It is noted that the processor 1001 may be implemented by one or more chips.

Each function of the base station 10 and the user terminal 20 is implemented by predetermined software (program) being read on hardware such as the processor 1001 and the memory 1002, by which the processor 1001 performs operations, controlling communication via the communication apparatus 1004, and controlling at least one of reading and writing of data at the memory 1002 and the storage 1003.

The processor 1001 controls the entire computer by, for example, operating an operating system. The processor 1001 may be implemented by a central processing unit (CPU) including an interface with peripheral equipment, a control apparatus, an operation apparatus, a register, and the like. For example, at least a part of the above-described control section 110 (210), transmitting/receiving section 120 (220), and the like may be implemented by the processor 1001.

The processor 1001 reads programs (program codes), software modules, data, and the like from at least one of the storage 1003 and the communication apparatus 1004 into the memory 1002, and performs various types of processing according to these. As the program, a program that causes a computer to execute at least a part of the operations described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), and other appropriate storage media. The memory 1002 may be referred to as a register, a cache, a main memory (primary storage apparatus), and the like. The memory 1002 can store programs (program codes), software modules, and the like that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, and other appropriate storage media. The storage 1003 may be referred to as a “secondary storage apparatus”.

The communication apparatus 1004 is hardware (transmission/reception device) for performing inter-computer communication via at least one of a wired network and a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmitting/receiving section 120 (220), the transmitting/receiving antenna 130 (230), and the like described above may be implemented by the communication apparatus 1004. The transmitting/receiving section 120 (220) may be implemented by physically or logically separating the transmitting section 120a (220a) and the receiving section 120b (220b) from each other.

The input apparatus 1005 is an input device for receiving input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, or the like). It is noted that the input apparatus 1005 and the output apparatus 1006 may be an integrated configuration (for example, touch panel).

The apparatuses such as the processor 1001 and the memory 1002 are connected by the bus 1007 for communicating information. The bus 1007 may be formed using a single bus, or may be formed using different buses for each apparatus.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented using at least one of these pieces of hardware.

### (Modifications)

It is noted that terms described in the present disclosure and terms necessary for understanding the present disclosure may be replaced with terms that have the same or similar meanings. For example, a channel, a symbol, and a signal (signal or signaling) may be interchangeable with one another. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission and reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, and specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, the slot may be a time unit based on numerology.

The slot may include a plurality of mini slots. Each mini slot may include one or more symbols in the time domain. Further, the mini slot may be referred to as a sub-slot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a mini slot, and a symbol each represent a time unit in signal transmission. The radio frame, the subframe, the slot, the mini slot, and the symbol may be called by other applicable names, respectively. It is noted that time units such as a frame, a subframe, a slot, a mini slot, and a symbol in the present disclosure may be interchangeable with each other.

For example, one subframe may be referred to as TTI, a plurality of consecutive subframes may be referred to as TTI, or one slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. It is noted that a unit representing a TTI may be referred to as a slot, a mini slot, or the like instead of a subframe.

Here, a TTI refers to, for example, a minimum time unit of scheduling in radio communication. For example, in the LTE system, a base station performs scheduling to allocate radio resources (a frequency bandwidth, transmit power, and the like that can be used in each user terminal) to each user terminal in TTI units. It is noted that the definition of a TTI is not limited to this.

A TTI may be a transmission time unit of a channel-coded data packet (transport block), a code block, a codeword, and the like or may be a processing unit of scheduling, link adaptation, and the like It is noted that, when a TTI is given, a time interval (for example, the number of symbols) to which a transport block, a code block, a codeword, or the like is actually mapped may be shorter than the TTI.

It is noted that, when one slot or one mini slot is referred to as a TTI, one or more TTIs (that is, one or more slots or one or more mini slots) may be a minimum time unit of scheduling. The number of slots (the number of mini slots) constituting the minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

It is noted that, a long TTI (such as a usual TTI or a subframe) may be replaced with a TTI having a time duration exceeding 1 ms. A short TTI (such as a shortened TTI) may be replaced with a TTI having a TTI length less than the TTI length of a long TTI and more than or equal to 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

An RB may include one or more symbols in the time domain, and may have a length of one slot, one mini slot, one subframe, or one TTI. One TTI, one subframe, and the like may each include one or more resource blocks.

It is noted that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource domain of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to assume transmission/reception of a predetermined signal/channel outside the active BWP. It is noted that a “cell”, a “carrier”, and the like in the present disclosure may be interchangeable with “BWP”.

It is noted that the structures of radio frames, subframes, slots, mini slots, symbols, and the like described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, and the like described in the present disclosure may be represented using absolute values, or may be represented using relative values with respect to predetermined values, or may be represented using other corresponding information. For example, a radio resource may be instructed by a predetermined index.

The names used for parameters and the like in the present disclosure are in no respect limiting. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, and the like described in the present disclosure may be represented using any of a variety of different technologies. For example, data, an instruction, a command, information, a signal, a bit, a symbol, a chip, and the like, which may be referred to throughout the above description, may be represented by a voltage, a current, an electromagnetic wave, a magnetic field or a magnetic particle, an optical field or an optical photon, or any combination of these.

Information, signals, and the like can be output in at least one of a direction from a higher layer to a lower layer or a direction from a lower layer to a higher layer. Information, signals, and the like may be input and output via a plurality of network nodes.

Input and output information, signals, and the like may be stored in a specific location (for example, memory), or may be managed using a measurement table. The input/output information, signals, and the like can be overwritten, updated, or appended. The output information, signals, and the like may be deleted. Information, signals, and the like that have been input may be transmitted to another apparatus.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

It is noted that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC Connection Setup message, an RRC Connection Reconfiguration message, and the like. Further, notification of the MAC signaling may be performed using, for example, a MAC control element (CE).

Also, notification of predetermined information (for example, notification of information to the effect that “X holds”) does not necessarily have to be sent explicitly, and can be sent implicitly (for example, by not notifying this predetermined information, by reporting another piece of information, and the like).

Determination may be performed using a value represented by one bit (0 or 1), or may be performed using a Boolean represented by true or false, or may be performed by comparing numerical values (for example, comparison with a predetermined value).

Software, regardless of whether it is referred to as software, firmware, middleware, microcode, or a hardware description language, or referred to by another name, should be interpreted broadly to mean an instruction, an instruction set, a code, a code segment, a program code, a program, a subprogram, a software module, an application, a software application, a software package, a routine, a subroutine, an object, an executable file, an execution thread, a procedure, a function, and the like.

Moreover, software, instructions, information, and the like may be transmitted and received via communication media. For example, when software is transmitted from a website, a server, or another remote source by using at least one of a wired technology (coaxial cable, optical fiber cable, twisted pair, digital subscriber line (DSL), or the like) and a wireless technology (infrared rays, microwaves, and the like), at least one of the wired technology and the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station and the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

At least one of the base station and the mobile station may be referred to as a transmission apparatus, a reception apparatus, a radio communication apparatus, and the like. It is noted that at least one of the base station or the mobile station may be a device mounted on a moving body (moving object), a moving body itself, and the like.

The moving body refers to a movable object, the moving speed is arbitrary, and naturally includes a case in which the moving body is stopped. The moving body includes, for example, a vehicle, a transport vehicle, an automobile, a motorcycle, a bicycle, a connected car, an excavator, a bulldozer, a wheel loader, a dump truck, a forklift, a train, a bus, a rear car, a human-powered vehicle, a ship and other watercraft, an airplane, a rocket, an artificial satellite, a drone, a multicopter, a quadcopter, a balloon, and objects mounted thereon, and is not limited thereto. Further, the moving body may be a moving body that autonomously travels based on an operation command.

The moving body may be a transportation (for example, a car, an airplane, or the like), an unmanned moving body (for example, a drone, an autonomous car, or the like), or a (manned or unmanned) robot. It is noted that at least one of the base station and the mobile station also includes an apparatus that does not necessarily move during a communication operation. For example, at least one of the base station and the mobile station may be an Internet of Things (IoT) device such as a sensor.

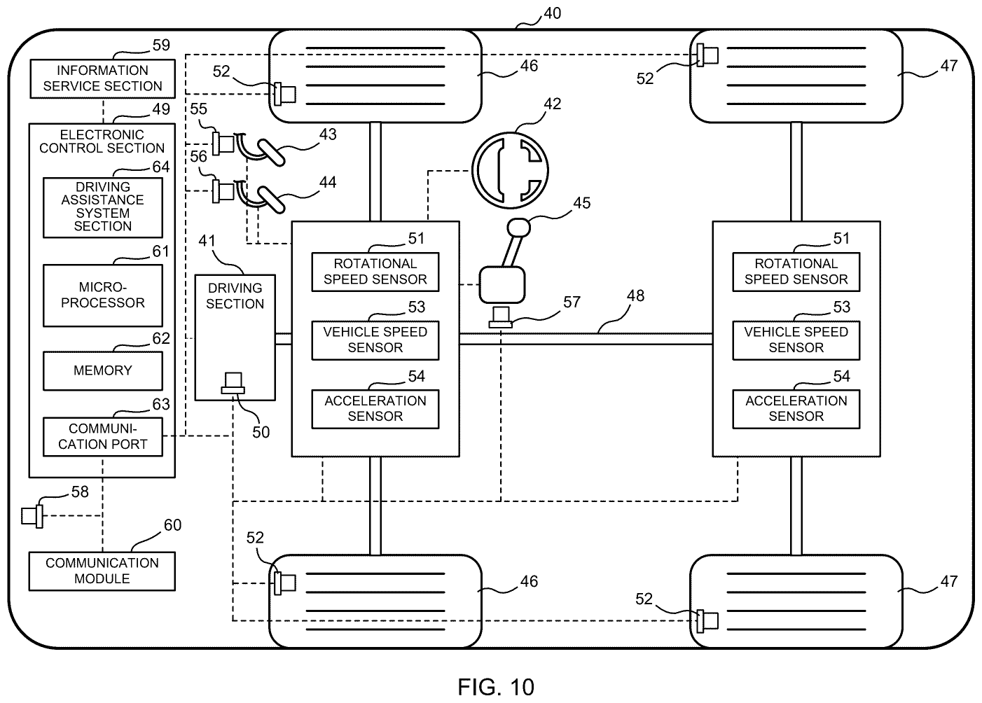

FIG. 10 is a diagram illustrating an example of a vehicle according to one embodiment. A vehicle 40 includes a drive unit 41, a steering unit 42, an accelerator pedal 43, a brake pedal 44, a shift lever 45, left and right front wheels 46, left and right rear wheels 47, an axle 48, an electronic control unit 49, various sensors (includes a current sensor 50, a rotation speed sensor 51, an air pressure sensor 52, a vehicle speed sensor 53, an acceleration sensor 54, an accelerator pedal sensor 55, a brake pedal sensor 56, a shift lever sensor 57, and an object detection sensor 58), an information service unit 59, and a communication module 60.

The drive unit 41 includes, for example, at least one of an engine, a motor, and a hybrid of an engine and a motor. The steering unit 42 includes at least a steering wheel (also referred to as a handle), and is configured to steer at least one of the front wheel 46 and the rear wheel 47 based on the operation of the steering wheel operated by a user.

The electronic control unit 49 includes a microprocessor 61, a memory (ROM, RAM) 62, and a communication port (for example, an input/output (IO) port) 63. Signals from the various sensors 50 to 58 provided in the vehicle are input to the electronic control unit 49. The electronic control unit 49 may be referred to as an electronic control unit (ECU).

The signals from the various sensors 50 to 58 include a current signal from the current sensor 50 that senses the current of the motor, a rotation speed signal of the front wheel 46/the rear wheel 47 acquired by the rotation speed sensor 51, an air pressure signal of the front wheel 46/the rear wheel 47 acquired by the air pressure sensor 52, a vehicle speed signal acquired by the vehicle speed sensor 53, an acceleration signal acquired by the acceleration sensor 54, a depression amount signal of the accelerator pedal 43 acquired by the accelerator pedal sensor 55, a depression amount signal of the brake pedal 44 acquired by the brake pedal sensor 56, an operation signal of the shift lever 45 acquired by the shift lever sensor 57, a detection signal for detecting an obstacle, a vehicle, a pedestrian, and the like acquired by the object detection sensor 58, and the like.

The information service unit 59 includes various devices for providing (outputting) various types of information such as driving information, traffic information, and entertainment information, such as a car navigation system, an audio system, a speaker, a display, a television, and a radio, and one or more ECUs that control these devices. The information service unit 59 provides various types of information/services (for example, multimedia information/multimedia services) to an occupant of the vehicle 40 using information acquired from an external device via the communication module 60 or the like.

The information service unit 59 may include an input device (for example, a keyboard, a mouse, a microphone, a switch, a button, a sensor, a touch panel, or the like) that receives an input from the outside, or may include an output device (for example, a display, a speaker, an LED lamp, a touch panel, or the like) that performs an output to the outside.

A driving assistance system unit 64 includes various devices for providing functions for preventing an accident in advance and reducing a driving load of a driver, such as a millimeter wave radar, light detection and ranging (LiDAR), a camera, a positioning locator (for example, global navigation satellite system (GNSS) or the like), map information (for example, a high definition (HD) map, an autonomous vehicle (AV) map, and the like), a gyro system (for example, an inertial measurement unit (IMU), an inertial navigation system (INS), or the like), an artificial intelligence (AI) chip, and an AI processor, and one or more ECUs for controlling these devices. Further, the driving assistance system unit 64 also transmits and receives various types of information via the communication module 60 so as to achieve a driving assistance function or an automatic driving function.

The communication module 60 can communicate with the microprocessor 61 and components of the vehicle 40 via the communication port 63. For example, the communication module 60 transmits and receives data (information) to and from the drive unit 41, the steering unit 42, the accelerator pedal 43, the brake pedal 44, the shift lever 45, the left and right front wheels 46, the left and right rear wheels 47, the axle 48, the microprocessor 61 and the memory (ROM, RAM) 62 in the electronic control unit 49, and the various sensors 50 to 58 provided in the vehicle 40 via the communication port 63.

The communication module 60 is a communication device that can be controlled by the microprocessor 61 of the electronic control unit 49 and can communicate with an external device. For example, various types of information are transmitted and received to and from an external device via radio communication. The communication module 60 may be either inside or outside the electronic control unit 49. The external device may be, for example, the base station 10, the user terminal 20, or the like described above. Furthermore, the communication module 60 may be, for example, the base station 10 and the user terminal 20 described above, and the like (may function as the base station 10, the user terminal 20, and the like).

The communication module 60 may transmit at least one of the above-described signals from the various sensors 50 to 58 input to the electronic control unit 49, information obtained based on the signals, and information based on an input from the outside (user) obtained via the information service unit 59 to the external device via radio communication. The electronic control unit 49, the various sensors 50 to 58, the information service unit 59, and the like may be referred to as input units that receive inputs. For example, the PUSCH transmitted by the communication module 60 may include information based on the above input.

The communication module 60 receives various types of information (traffic information, traffic signal information, inter-vehicle information, and the like) transmitted from an external device, and displays the information on the information service unit 59 provided in the vehicle. The information service unit 59 may be referred to as an output unit that outputs information (for example, information is output to a device such as a display or a speaker based on a PDSCH (or data/information decoded from the PDSCH) received by the communication module 60).

The communication module 60 also stores various types of information received from external devices in the memory 62 available by the microprocessor 61. Based on the information stored in the memory 62, the microprocessor 61 may control the drive unit 41, the steering unit 42, the accelerator pedal 43, the brake pedal 44, the shift lever 45, the left and right front wheels 46, the left and right rear wheels 47, the axle 48, the various sensors 50 to 58, and the like provided in the vehicle 40.

The base station in the present disclosure may be interchangeable with a user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. In addition, the terms such as “uplink” and “downlink” may be interchangeable with terms corresponding to terminal-to-terminal communication (for example, “sidelink”). For example, an uplink channel, a downlink channel, and the like may be interchangeable with a sidelink channel.

Similarly, the user terminal in the present disclosure may be replaced with a base station. In the case, the base station 10 may have the function of the above-mentioned user terminal 20.

In the present disclosure, the operation performed by the base station may be performed by an upper node thereof in some cases. In a network including one or a plurality of network nodes with a base station, it is clear that various operations performed for communication with a terminal can be performed by a base station, one or more network nodes (for example, mobility management entity (MME) and serving-gateway (S-GW) are possible, but are not limitations) other than the base station, or a combination thereof.

Each aspect/embodiment described in the present disclosure may be used alone, used in combination, or switched in association with execution. Further, the order of processing procedures, sequences, flowcharts, and the like of the aspects/embodiments described in the present disclosure may be re-ordered as long as there is no inconsistency. For example, for the method described in the present disclosure, various step elements are presented by using an illustrative order, and the method is not limited to the presented specific order.

Each aspect/embodiment described in the present disclosure may be applied to a system using Long-Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG(x is, for example, an integer or decimal)), Future Radio Access (FRA), New-Radio Access Technology (RAT), New Radio (NR), New radio access (NX), Future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WIMAX (registered trademark)), IEEE 802.20, Ultra-WideBand (UWB), Bluetooth (registered trademark), or another appropriate radio communication method, a next generation system extended, modified, generated, or prescribed based on those described above, and the like. Further, a plurality of systems may be combined (for example, a combination of LTE or LTE-A and 5G, and the like) and applied.

The phrase “based on” used in the present disclosure does not mean “based only on”, unless otherwise specified. In other words, the phrase “based on” means both “based only on” and “based at least on”.

Any reference to an element using designations such as “first” and “second” used in the present disclosure does not generally limit the amount or order of these elements. These designations can be used in the present disclosure, as a convenient way of distinguishing between two or more elements. In this way, reference to the first and second elements does not imply that only two elements may be employed, or that the first element must precede the second element in some way.

The term “determining” used in the present disclosure may include a wide variety of operations. For example, “determining” may be regarded as “determining” judging, calculating, computing, processing, deriving, investigating, looking up, search, inquiry (for example, looking up in table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on.

In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

“Determining” may be interchangeable with “assuming”, “expecting”, “considering”, and the like.

The “maximum transmit power” described in the present disclosure may mean the maximum value of the transmit power, may mean the nominal UE maximum transmit power, or may mean the rated UE maximum transmit power.

The terms “connected” and “coupled” used in the present disclosure, or all variations thereof mean all direct or indirect connections or coupling between two or more elements, and can include the presence of one or more intermediate elements between two elements “connected” or “coupled” with each other. The coupling or connection between the elements may be physical, logical, or a combination of these. For example, the term “connection” is interchangeable with “access”.

In the present disclosure, when two elements are connected, the two elements can be considered to be “connected” or “coupled” with each other by using one or more electrical wires, cables, printed electrical connections, and the like, and using, as some non-limiting and non-inclusive examples, electromagnetic energy and the like having a wavelength in a radio frequency domain, a microwave domain, and an optical (both visible and invisible) domain.

In the present disclosure, the phrase “A and B are different” may mean “A and B are different from each other”. It is noted that the phrase may mean that “A and B are different from C”. The terms such as “leave”, “coupled”, and the like may be interpreted similarly to “different”.

In the present disclosure, when “include”, “including”, and variations thereof are used, these terms are intended to be inclusive similarly to the term “comprising”. The term “or” used in the present disclosure is intended not to be an exclusive-OR.

In the present disclosure, when articles in English such as “a”, “an”, and “the” are added in translation, the present disclosure may include the plural forms of nouns that follow these articles.

Although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined based on the description of claims. Consequently, the description of the present disclosure is provided only for the purpose of explaining examples, and should by no means be construed to limit the invention according to the present disclosure in any way.

1. A terminal comprising:
a control section configured to determine a resource in which an uplink (UL) signal resource and a downlink (DL) signal resource are configurable in the same time resource in one physical resource block; and
a transmitting/receiving section configured to perform, in the resource to be determined, at least one of reception of a specific DL signal used for initial access and transmission of a specific UL signal used for initial access.

2. The terminal according to claim 1, wherein a frequency resource of the UL signal resource and a frequency resource of the DL signal resource are configurable while at least partially overlapping each other.

3. The terminal according to claim 1, wherein the DL signal in the DL signal resource to be configured includes at least one of information on monitoring of a physical downlink control channel, system information, and information on the UL signal.

4. The terminal according to claim 1, wherein the control section is configured to determine at least one of an additional UL signal resource and an additional DL signal resource based on a length of the UL signal resource to be configured and a length of the DL signal resource to be configured.

5. A radio communication method for a terminal, the radio communication method comprising:
determining a resource in which an uplink (UL) signal resource and a downlink (DL) signal resource are configurable in the same time resource in one physical resource block; and
performing, in the resource to be determined, at least one of reception of a specific DL signal used for initial access and transmission of a specific UL signal used for initial access.

6. A base station comprising:
a control section configured to determine a resource in which an uplink (UL) signal resource and a downlink (DL) signal resource are configurable in the same time resource in one physical resource block; and
a transmitting/receiving section configured to perform, in the resource to be determined, at least one of transmission of a specific DL signal used for initial access and reception of a specific UL signal used for initial access.
